(19) United States
(12) Patent Application Publication
(10) Pub. No.: US 2009/0226352 A1
(43) Pub. Date: Sep. 10, 2009

(54) METHOD FOR RECOVERING NOBLE METAL

(75) Inventors: Hsi-Yen HSU, Taipei City (TW); Tsui Lin, Hsinchu City (TW)

Correspondence Address: LOWE HAUPTMAN HAM & BERNER, LLP, 1700 DIAGONAL ROAD, SUITE 300, ALEXANDRIA, VA, 22314, US

(73) Assignee: INDUSTRIAL TECHNOLOGY RESEARCH INSTITUTE, Hsinchu (TW)

(21) Appl. No.: 12/344,113

(22) Filed: Dec. 24, 2008

(30) Foreign Application Priority Data
Mar. 7, 2008 (TW) 097108136

(51) Int. Cl. C22B 11/00; C01G 55/00

(52) U.S. Cl. 423/22; 423/27

(57) ABSTRACT

An embodiment of the invention provides a method for recovering noble metal, which includes providing a carbon-supported catalyst containing a noble metal and a carbonaceous material and separating the noble metal and the carbonaceous material by using various oxidizing solutions to dissolve the noble metal stepwise from the carbon-supported catalyst.

### CROSS REFERENCE TO RELATED APPLICATIONS

This Application claims priority of Taiwan Patent Application No. 097108136, filed on Mar. 7, 2008, the entirety of which is incorporated by reference herein.

### BACKGROUND OF THE INVENTION

1. Field of the Invention

The present invention relates to a method for recovering noble metal, and in particular relates to recover of fuel cell noble metal.

2. Description of the Related Art

Due to the gradual depletion of conventional fossil fuels and the environmental impact caused by using fossil fuels, development of alternative energy sources with low pollution and high electrical efficiency is becoming more and more important.

Among the many kinds of new energy sources developed, such as solar cells, bioenergy, or fuel cells, fuel cells have attracted much attention due to their high electrical efficiency of about 55% and low pollution. Thermal electric power from fossil fuel needs a plurality of energy transformation steps. For example, the fuel is first burned to transform chemical energy into thermal energy. The thermal energy is then transformed into kinetic energy, followed by transformation into electrical energy. Different from fossil fuel, the chemical energy of fuel cells can be directly transformed into electrical energy. By using a catalytic electrode, the reaction rate between the fuel of the fuel cell, such as hydrogen, and the oxidant, such as oxygen, may be improved. The efficiency of the fuel cell is much higher than that produced by thermal electric power. Further, the by-product of the fuel cell is substantially water, without pollutant effects on the environment.

In the application of the fuel cell as shown in FIG. 1, a catalyst of noble metal is usually used to enhance electrical efficiency. For example, platinum is often used as the catalyst in a heterogeneous catalytic reaction. When a hydrogen molecule 14 is adsorbed by a platinum catalytic electrode layer 12, the hydrogen molecule 14 will be divided into two hydrogen atoms. Due to the electrochemical potential difference, the hydrogen atom will be oxidized into a proton 14a (H⁺) and an electron 14b. Usually, in order to further increase the reaction area, a carbon support, such as carbon black, graphitized carbon black, activated carbon, graphitized activated carbon, or carbon nanotube, with high dispersion will be used to support the platinum catalyst. A catalyst supported by the carbon support is called a carbon-supported catalyst. Usually, the platinum catalytic electrode layer 12 and the proton exchange membrane 10 together construct the membrane electrode assembly (MEA) 15. The generated proton 14a may penetrate through the proton exchange membrane 10 and move to the cathode. The proton 14a will react with oxygen ion 16a of oxygen molecule 16 and be transformed into water 18 without pollution. The electron 14b may be transmitted to a supporting carbon structure through an adjacent platinum conductor, followed by being transmitted to an outside circuit 19 for use. Although the platinum catalyst can oxidize hydrogen atom into protons effectively, the cost of the platinum catalyst is very expensive, as platinum now costs 1260 U.S. dollars per ounce. One of the reasons why fuel cells have high electrical efficiency but low popularization is that the manufacturing cost is too high, wherein the cost of the metal catalyst is more than 50% of the total cost.

After a fuel cell is operated for a period of time, the catalytic ability of the catalyst will be degraded, leading to degraded electrical efficiency of the fuel cell because the surface of the catalyst may be poisoned by other compounds in the reactive environment or covered by deposit or residual formed during reaction. Therefore, if the noble metal in the membrane electrode assembly can be recovered and for reused, manufacturing costs can be reduced and popularity and applications of the fuel cells can be increased.

A conventional method for recovering noble metal is by burning the membrane electrode assembly to separate the noble metal with the proton exchange membrane and other carbonaceous materials, such as a carbon paper or a carbon cloth serving as a gas diffusion layer. However, the membrane electrode assembly of a fuel cell includes a polymer structure containing fluorine, such as a Nafion proton exchange membrane (polytetrafluoroethylene) produced by DuPont company and a function group of sulfonic acid used for proton transportation. When a conventional burning method is applied, a corrosive gas, such as HF, CFC, and SOₓ is easily generated, leading to increased waste gas treatment costs and environmental pollution. Because the membrane electrode assembly includes a lot of noble metal, the noble metal will enhance the oxidation reaction of the carbonaceous materials under high temperature. Thus, thermal cracking rate of the carbonaceous materials is increased, wherein a lot of heat is immediately released. In serious situations, air blast or poisonous gas leakage may also occur. In addition, the anode catalyst of the fuel cell is often made of an alloy of ruthenium and platinum for adjusting energy levels to reduce possible poisonous effects. However, when ruthenium is burned, RuO₄ gas will be produced, which is very poisonous and is volatile having a boiling point of 100° C. Moreover, a large amount of the noble metal may be dissipated along with waste air through a chimney. There also may be some volatile transition metal carbonyls generated during the process, reducing the recovery rate of the noble metal. Thus, a novel method for recovering noble metal safely and efficiently is desired.

### BRIEF SUMMARY OF THE INVENTION

According to an illustrative embodiment of the invention, a method for recovering noble metal is provided. The method comprises providing a carbon-supported catalyst containing a noble metal and a carbonaceous material and separating the noble metal and the carbonaceous material by using various oxidizing solutions to dissolve the noble metals stepwise from the carbon-supported catalyst.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows an illustrative view of a fuel cell;

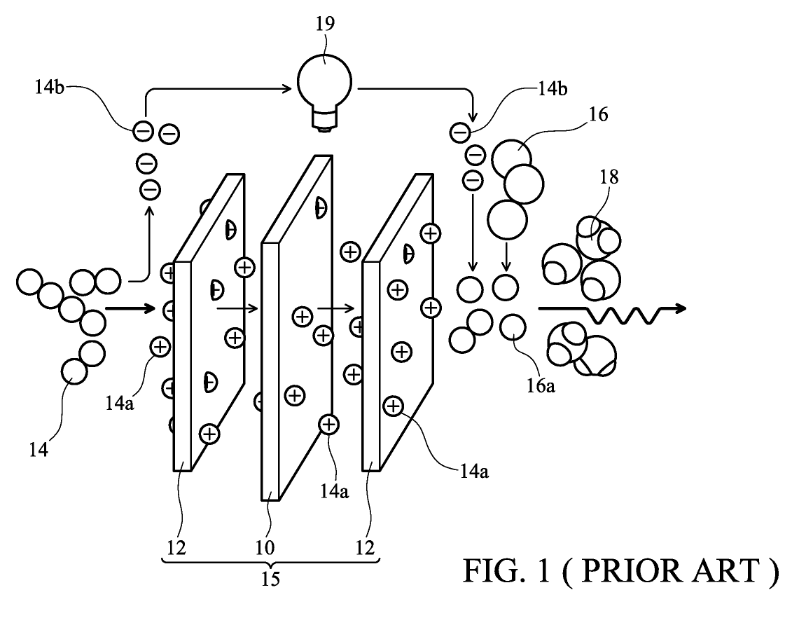

FIG. 2 shows a flow chart of a method for recovering noble metal according to an embodiment of the invention; and

FIG. 3 shows a cross-sectional view of a membrane electrode assembly.

### DETAILED DESCRIPTION OF THE INVENTION

The following description is made for the purpose of illustrating the general principles of the invention and should not be taken in a limiting sense. The scope of the invention is best determined by reference to the appended claims.

Embodiments of the present invention provide a method for recovering noble metal, wherein the noble metal salt may be dissolved and separated from other materials, such as polymer materials or carbonaceous materials for use.

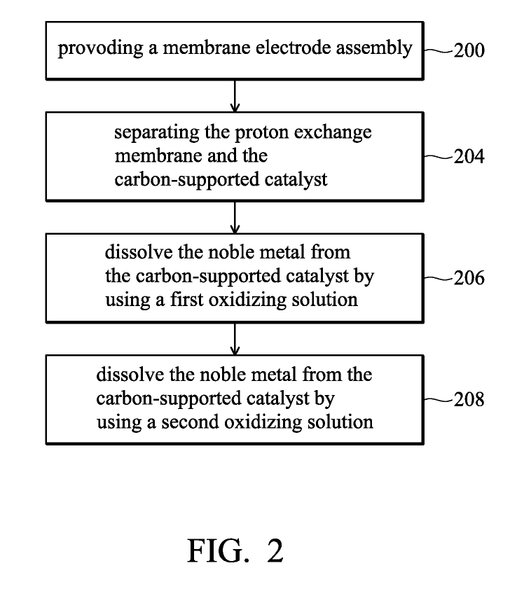

In one embodiment, a method for recovering noble metal is by dissolving a noble metal stepwise, by using various oxidizing solutions. FIG. 2 shows a flow chart of a method for recovering noble metal according to an embodiment of the invention. First, a membrane electrode assembly including at least a noble metal is provided (Step 200). The membrane electrode assembly may be derived from a proton exchange membrane fuel cell, a direct methanol fuel cell, or the like.

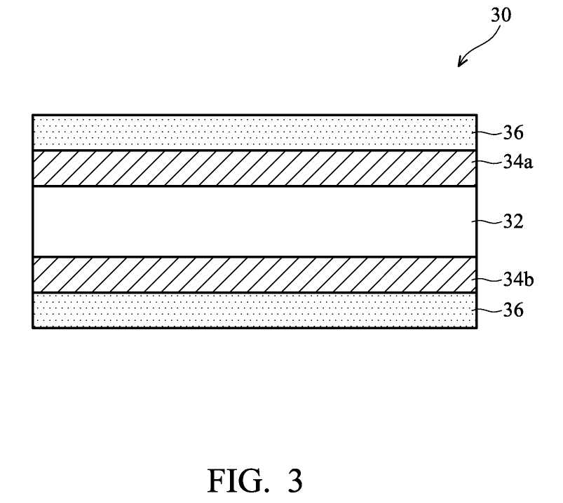

FIG. 3 shows a cross-sectional view of a membrane electrode assembly 30. Generally, a noble metal is included in the anode catalytic electrode layer 34a and the cathode catalytic electrode layer 34b. Usually, the anode catalytic electrode layer 34a includes a platinum-ruthenium catalyst and the cathode catalytic electrode layer 34b includes a platinum catalyst. In addition, other noble metals may also be used as the catalyst, such as gold, palladium, rhodium, rhenium, iridium, or combinations thereof. In another case, nano particles, such as gold nano particles with diameters ranging from about 2 nm to 3 nm, may be deposited overlying a surface of a noble metal, such as a platinum catalyst to elevate the oxidation potential of the catalyst, thus increasing its lifetime. Usually, in order to further increase the reaction area, a carbon support, such as carbon black, graphitized carbon black, activated carbon, graphitized activated carbon, or carbon nanotube, with higher dispersion will be used to support the noble metal catalyst. The catalyst supported by the carbon support is called a carbon-supported catalyst.

As shown in FIG. 3, the catalytic electrode layers are located overlying opposite surfaces of the proton exchange membrane 32, respectively. The proton generated in the fuel cell may be transported through the proton exchange membrane 32. Usually, gas diffusion layers 36 are further formed overlying the catalytic electrode layers. Gas, such as hydrogen or oxygen, may be diffused into the catalytic electrode layer 34a or 34b through the gas diffusion layers 36. A common proton exchange membrane is, for example, a Nafion proton exchange membrane (polytetrafluoroethylene) produced by DuPont company. A common gas diffusion layer includes, for example, a carbon paper or a carbon cloth.

As shown in FIG. 2, after the step 200 of providing a membrane electrode assembly is completed, step 204 of separating the proton exchange membrane and the carbon-supported catalyst is performed. In an embodiment, a polar stripping solvent having a dielectric constant of more than about 2 is used to separate the proton exchange membrane and the carbon-supported catalyst adhered thereon. The polar stripping solvent may have a boiling point smaller than about 200° C. and its molecule may have about 1 to 6 carbons. Suitable polar stripping solvents may include alcohol (e.g. methanol, ethanol, 1-butanol, or isopropanol), ether (e.g. ethyl ether, ethylene glycol dimethyl ether, ethylene glycol ether, ethylene glycol ethyl ether, or tetrahydrofuran), keton (e.g. cyclohexanone, methyl ethyl ketone, methyl tertiary butyl ketone), ester (e.g. propyleneglycol methyl ether acetate, ethly-2-ethoxyacetate, ethyl-3-ethoxypropionate, isoamyl acetate), or combinations thereof. By using the polar stripping solvent and performing suitable heating and stirring, the proton exchange membrane 32 may be separated from other structures in the membrane electrode assembly 30. For example, the membrane electrode assembly 30 may be stirred in a polar stripping solvent at about 25 to 90° C. for about 0.5 to 5 hours. The surface of the proton exchange membrane treated by the polar stripping solvent may have some black deposit. The black deposit may be, for example, the carbonaceous materials of the carbon-supported catalyst or a small amount of platinum catalyst. It should be noted that when the platinum metal has a diameter as small as about 10 nm, the surface of the platinum metal will be black, which is so-called platinum black. The proton exchange membrane treated by the polar stripping solvent can be dried and then be for reused.

After removal of the proton exchange membrane, the noble metal is separated from the residual carbon-supported catalyst and other carbonaceous materials, such as a carbon paper or a carbon cloth, which is used as a gas diffusion layer, stepwise, by using various oxidizing solutions. The oxidizing solution may include an acid oxidizing solution or a basic oxidizing solution. Suitable acid oxidizing solutions may include, for example, a solution of aqua regia, hydrochloric acid, nitric acid, hydrogen peroxide, sulfuric acid, phosphoric acid, or combinations thereof. Suitable basic oxidizing solutions may include, for example, a hypochlorite solution (e.g. sodium hypochlorite solution), an alkali metal hydroxide solution (e.g. sodium hydroxide solution or potassium hydroxide solution), an alkali earth metal hydroxide solution (e.g. magnesium hydroxide solution or calcium hydroxide solution), or combinations thereof. After removal of the proton exchange membrane and before adding the residual solid including, such as carbon cloth and the carbon-supported catalyst, into the oxidizing solution, the residual solid is usually cut into chips to increase reaction area. After suitable heating and stirring, the noble metal may be dissolved out of the carbon-supported catalyst, followed by filtration and thus separated from other materials, such as carbonaceous material or carbon cloth. The above process is a first step recovery process (step 206). Heating temperature and stirring time may be adjusted depending on the kinds and/or concentration of the oxidizing solution used. Generally, the heating temperature may range from between about 25° C. and 200° C. The stirring time may range from between about 0.5 hour and 5 hours. In an embodiment, the heating temperature ranges preferably between about 60° C. and 100° C. and the stirring time ranges preferably between about 1 hour and 2 hours.

After the filtration mentioned above, the residual filter cake may be added into another oxidizing solution to further dissolve the noble metal out from the residual filter cake. The process is a second step recovery process (step 208). Using different kinds of oxidizing solutions may further dissolve the noble metal out of the residual carbon-supported catalyst, which was not efficiently accomplished when using the first kind of oxidizing solution. In one embodiment, the noble metal is dissolved by using an acid oxidizing solution, followed by using a basic oxidizing solution. For example, a solution of aqua regia may be used first, followed by using an NaOCl/NaOH solution. In another embodiment, the noble metal is dissolved by using a basic oxidizing solution, followed by using an acid oxidizing solution. For example, an NaOCl/NaOH solution may be used first, followed by using a solution of aqua regia. In yet another embodiment, the noble metal is dissolved stepwise in three recovery steps. In the recovery steps, the kinds and/or the concentrations of the oxidizing solutions used may all be different or partially repeated. The heating temperature and the stirring time of each of the recovery steps may be adjusted depending on specific situations. Generally, the heating temperature may range from between about 25° C. and 200° C., preferably between about 60° C. and 100° C. The stirring time may range from between about 0.5 hour and 5 hours, preferably between about 1 hour and 2 hours.

In an embodiment, when recovering a platinum catalyst and a ruthenium catalyst of a membrane electrode assembly of a fuel cell, the noble metal is dissolved out of the carbon-supported catalyst by using an acid oxidizing solution, followed by using a basic oxidizing solution. The recovery rate of the platinum is more than about 90% and the recovery rate of the ruthenium is more than about 85%. In another embodiment, a basic oxidizing solution is used first, followed by using an acid oxidizing solution, wherein the recovery rate of the platinum is more than about 95% and the recovery rate of the ruthenium is more than about 85%. In yet another embodiment, three continuous recovery steps are performed. In the first step, the noble metal is dissolved out of the carbon-supported catalyst by first using an acid oxidizing solution. Then, the residual noble metal still in the filter cake is further dissolved out of the filter cake by using a basic oxidizing solution in the second step. Following, in the third step, the noble metal is further dissolved out from the residual filter cake by using an acid oxidizing solution. The recovery rate of the platinum is more than about 99.3% and the recovery rate of the ruthenium is more than about 95.3%.

Some examples are provided as follows for further understanding of the recovery process of the embodiments of the invention, wherein the recovery rate of each example is also provided.

### EXAMPLE 1

First, a membrane electrode assembly was put into 100 ml of a 50 wt % solution of isopropanol. The membrane electrode assembly is similar to the structure shown in FIG. 3. Then, the proton exchange membrane was separated with the carbon cloth and the carbon-supported catalyst by stirring and heating at about 80° C. for 1 hour. The proton exchange membrane was washed by an isopropanol solution to remove the carbon powder on the surface. The proton exchange membrane was then dried for reuse.

Then, the residual solid including the carbon-supported catalyst and the carbon cloth serving as a gas diffusion layer was cut into small chips, wherein each gram of the chips included 0.050 g of platinum and 0.012 g of ruthenium, wherein the amounts of platinum and ruthenium are counted by the volume fraction of the original membrane electrode used. 10 g of the chips was added into a mixture of a solution of 30 ml of aqua regia and 10 ml of deionized water. The mixture was then heated to about 100° C. and stirred for about 1 hour. The mixture was then filtered and the obtained filtrate was detected by an inductive coupling plasma (ICP) process. From the ICP result, 0.466 g of platinum and 0.101 g of ruthenium were obtained.

Then, the residual filter cake was added into a mixture of 100 ml of NaOCl solution and 10 ml of NaOH solution (2N). The mixture was then heated to about 60° C. for 2 hours. The mixture was then filtered and detected by an ICP test. The ICP result indicated that 0.0007 g of platinum and 0.0005 g of ruthenium were obtained. After using the two oxidizing solutions, a total amount of 0.467 g of platinum and 0.102 g of ruthenium was obtained. The recovery rate of platinum was 93.4% and the recovery rate of ruthenium was 85.0%.

### EXAMPLE 2

First, a membrane electrode assembly was put into 100 ml of a 50 wt % solution of isopropanol. The membrane electrode assembly is similar to the structure shown in FIG. 3. Then, the proton exchange membrane was separated with the carbon cloth and the carbon-supported catalyst by stirring and heating at about 80° C. for 1 hour. The proton exchange membrane was washed by an isopropanol solution to remove the carbon powder on the surface. The proton exchange membrane was then dried for reuse.

Then, the residual solid including the carbon-supported catalyst and the carbon cloth serving as a gas diffusion layer was cut into small chips, wherein each gram of the chips included 0.057 g of platinum and 0.015 g of ruthenium, wherein the amounts of platinum and ruthenium are counted by the volume fraction of the original membrane electrode used. 10 g of the chips was added into a mixture of 100 ml of NaOCl solution and 10 ml of NaOH solution (2N). The mixture was then heated to about 60° C. for 2 hours. The mixture was then filtered and detected by an ICP test. The ICP result indicated that 0.0004 g of platinum and 0.0005 g of ruthenium were obtained.

Then, the residual filter cake was added into a mixture of a solution of 40ml of aqua regia and 10 ml of deionized water. The mixture was then heated to about 100° C. and stirred for about 1 hour. The mixture was then filtered and the obtained filtrate was detected by an ICP test. From the ICP result, 0.562 g of platinum and 0.130 g of ruthenium were obtained. After using the two oxidizing solutions, a total amount of 0.562 g of platinum and 0.131 g of ruthenium was obtained. The recovery rate of platinum was 98.6% and the recovery rate of ruthenium was 87.3%.

### EXAMPLE 3

First, a membrane electrode assembly was put into 100 ml of a 50 wt % solution of isopropanol. The membrane electrode assembly is similar to the structure shown in FIG. 3. Then, the proton exchange membrane was separated with the carbon cloth and the carbon-supported catalyst by stirring and heating at about 80° C. for 1 hour. The proton exchange membrane was washed by an isopropanol solution to remove the carbon powder on the surface. The proton exchange membrane was then dried for reuse.

Then, the residual solid including the carbon-supported catalyst and the carbon cloth serving as a gas diffusion layer was cut into small chips, wherein each gram of the chips included 0.057 g of platinum and 0.015 g of ruthenium, wherein the amounts of platinum and ruthenium are counted by the volume fraction of the original membrane electrode used. 10 g of the chips was added into a mixture of a solution of 30 ml of aqua regia and 10 ml of deionized water. The mixture was then heated to about 100 ° C. and stirred for about 1 hour. The mixture was then filtered and the obtained filtrate was kept for a following detection step.

Then, the residual filter cake was added into a mixture of 100 ml of NaOCl solution and 10 ml of NaOH solution (2N). The mixture was then heated to about 60° C. for 2 hours. The mixture was then filtered and the obtained filtrate was kept for a following detection step.

Then, the residual cake was added into a mixture of a solution of 30 ml of aqua regia and 10 ml of deionized water. The mixture was then heated to about 100° C. and stirred for about 1 hour. The mixture was then filtered and the obtained filtrate was kept for a following detection step.

The obtained filtrates of the three recovery steps were detected by an ICP test. The ICP result indicated that a total amount of 0.566 g of platinum and 0.143 g of ruthenium was obtained. The recovery rate of platinum was 99.3% and the recovery rate of ruthenium was 95.3%.

The following Table shows the recovery methods used and the respective recovery rate of noble metal of the three examples.

| | TABLE | |
|---|---|---|
| | Mixture solution of | |
| | platinum and ruthenium | |
| | Recovery rate of | Recovery rate of |
| Examples of dissolving stepwise | platinum (%) | ruthenium (%) |
| First step: aqua regia | 93.4 | 85.0 |
| Second step: NaOCl/NaOH | | |
| First step: NaOCl/NaOH | 98.6 | 87.3 |
| Second step: aqua regia | | |
| First step: aqua regia | 99.3 | 95.3 |
| Second step: NaOCl/NaOH | | |
| Third step: aqua regia | | |

As shown in the Table, dissolving the noble metal from the filter cake stepwise leads to a good recovery rate. The recovery rates of platinum are all more than about 90% and the recovery rates of ruthenium are all more than about 85%. Wherein, when a basic oxidizing solution was used first, the recovery rate of the noble metal was a minimal amount. However, after an acid oxidizing solution was used, the recovery rate of the noble metal was much higher. It should be appreciated that for Example 2, when using a basic oxidizing solution before an acid oxidizing solution, a higher noble metal recovery rate resulted when compared to Example 1, when using an acid oxidizing solution before a basic oxidizing solution. Thus, there are some issues for further analysis. It may be possible that the basic oxidizing solution can destroy the surface of the carbon-supported surface more easily, so that the noble metal contacts with the oxidizing solution more easily, thus increasing the amount of the noble metal dissolved. The obtained platinum-ruthenium recovery solution may be reduced to metal or used directly in a noble metal salt solution state for a variety of applications.

The method for recovering noble metal of the embodiments of the invention has many advantageous features. The proton exchange membrane is removed by substantially using polar stripping solution without hurting the proton exchange membrane. After suitable treatment, the proton exchange membrane may be reused. Compared with the conventional burning method, recovering noble metal by using the oxidizing solution is safer and the recovery rate is higher. Using different kinds of oxidizing solutions may further dissolve the noble metal out of the carbon-supported catalyst, which was not efficiently accomplished when using the first kind of oxidizing solution. Thus, the amount of the recovery rate is improved, further improving reuse of the noble metal.

It should be appreciated that in the foregoing mentioned embodiments, although the carbon-supported catalyst is derived from a membrane electrode assembly and separated from a proton exchange membrane by using a polar stripping solvent, the embodiments of the invention are not limited thereto. The carbon-supported catalyst is not limited to be derived from a membrane electrode assembly and is not limited to derived from the carbon-supported catalyst adhered on the proton exchange membrane. Any content of the carbon-supported catalyst, from any kind of fuel cells may be recovered by using the recovering method of the embodiment of the invention.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for recovering noble metal, comprising:
providing a carbon-supported catalyst containing a noble metal and a carbonaceous material; and
separating the noble metal and the carbonaceous material by using various oxidizing solutions to dissolve the noble metal stepwise from the carbon-supported catalyst.

2. The method for recovering noble metal as claimed in claim 1, wherein the carbon-supported catalyst is derived from a membrane electrode assembly.

3. The method for recovering noble metal as claimed in claim 2, wherein the membrane electrode assembly is from a proton exchange membrane fuel cell.

4. The method for recovering noble metal as claimed in claim 2, wherein the membrane electrode assembly is from a direct methanol fuel cell.

5. The method for recovering noble metal as claimed in claim 2, wherein the membrane electrode assembly comprises a proton exchange membrane.

6. The method for recovering noble metal as claimed in claim 5, wherein the carbon-supported catalyst is adhered on the proton exchange membrane.

7. The method for recovering noble metal as claimed in claim 6, further comprising separating the proton exchange membrane and the carbon-supported catalyst.

8. The method for recovering noble metal as claimed in claim 7, wherein separating the proton exchange membrane and the carbon-supported catalyst comprises using a polar stripping solvent.

9. The method for recovering noble metal as claimed in claim 8, wherein the polar stripping solvent has a dielectric constant of more than about 2.

10. The method for recovering noble metal as claimed in claim 8, wherein the polar stripping solvent comprises alcohol, ether, ketone, ester, or combinations thereof.

11. The method for recovering noble metal as claimed in claim 1, wherein the noble metal comprise platinum, ruthenium, gold, palladium, rhodium, rhenium, iridium, or combinations thereof.

12. The method for recovering noble metal as claimed in claim 1, wherein the oxidizing solution comprises an acid solution, a basic solution, or combinations thereof.

13. The method for recovering noble metal as claimed in claim 12, wherein the acid solution comprises a solution of aqua regia, hydrochloric acid, nitric acid, hydrogen peroxide, sulfuric acid, phosphoric acid, or combinations thereof.

14. The method for recovering noble metal as claimed in claim 12, wherein the basic solution comprises a hypochlorite solution, an alkali metal hydroxide solution, an alkali earth metal hydroxide solution, or combinations thereof.

15. The method for recovering noble metal as claimed in claim 12, wherein the dissolution of the noble metal comprises using an acid oxidizing solution, followed by using a basic oxidizing solution.

16. The method for recovering noble metal as claimed in claim 15, wherein a recovery rate of the platinum is more than about 90% and a recovery rate of the ruthenium is more than about 85%.

17. The method for recovering noble metal as claimed in claim 12, wherein the dissolution of the noble metal comprises using a basic oxidizing solution, followed by using an acid oxidizing solution.

18. The method for recovering noble metal as claimed in claim 17, wherein a recovery rate of the platinum is more than about 95% and a recovery rate of the ruthenium is more than about 85%.
